(19) United States
(12) Patent Application Publication
(10) Pub. No.: US 2007/0002572 A1
(43) Pub. Date: Jan. 4, 2007

(54) Anti-collision luminous signaling device

(76) Inventors: Pascal Ewig, Paris (FR); Philippe Millet, Chaville (FR); Edouard Bonnefous, Saint Mande (FR)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/446,816

(22) Filed: Jun. 5, 2006

(30) Foreign Application Priority Data
Jun. 6, 2005 (FR) FR 0505720

(51) Int. Cl. F21V 9/16; B64D 47/02

(52) U.S. Cl. 362/470; 362/84; 362/240

(57) ABSTRACT

Luminous signaling device, in particular intended to be mounted on board an aircraft, comprising a plurality of lighting elements mounted on a support and elements for shaping the radiation emitted jointly by the lighting elements the said shaping elements being provided with reflection elements whose reflecting surfaces comprise at least one substantially conical portion. The optical axes of the lighting elements are oriented substantially perpendicularly with respect to a direction to be lit.

### BACKGROUND OF THE INVENTION

1. Field of the Invention

The present invention relates to a luminous signaling device and, in particular, to an anti-collision signaling device intended to be mounted on an aircraft. The present invention relates more especially to a luminous signaling device including a plurality of lighting elements mounted on a support and elements for shaping the radiation emitted jointly by the lighting elements, the said shaping elements being provided with reflection elements whose reflecting surfaces include a substantially conical generator.

2. Description of the Relevant Art

Document WO 03/095894 discloses a luminous signaling device including a reflector, exhibiting a cross section of parabolic general shape, inside which are mounted a network of mutually aligned electroluminescent diodes disposed in proximity to the focal axis of the parabola defined by the reflector. The electroluminescent diodes are oriented in the direction to be lit. The device also includes a focusing lens making it possible to redirect, towards the direction to be lit, the rays emitted by the diodes and which have not been reflected by the reflector.

Such a signaling device has the drawback of including a significant number of electroluminescent diodes to obtain a relatively high luminous radiation. Furthermore, this device requires a focusing lens, thereby substantially increasing its cost price, and proposes nothing in respect of an anti-collision device.

### SUMMARY OF THE INVENTION

The present invention is therefore aimed at remedying these drawbacks by proposing a luminous signaling device, especially adapted to be used as anti-collision device, which is compact and exhibits reduced energy consumption, for given illumination.

Another aim of the invention is to provide a luminous signaling device which makes it possible to obtain an asymmetric angular distribution of the luminous radiation.

According to one aspect of the invention, the luminous signaling device, in particular intended to be mounted on board an aircraft, includes a plurality of lighting elements mounted on a support and elements for shaping the radiation emitted jointly by the lighting elements. The reflecting surface of each of the reflection elements includes at least one substantially conical portion. According to one aspect of the invention, the optical axes of the lighting elements are oriented substantially perpendicularly with respect to a direction to be lit.

In other words, the lighting elements are positioned in such a way that a large part of the luminous radiation emitted is directed towards the reflecting surface of the reflection elements.

With such an arrangement, it thus becomes possible to obtain lighting efficiency substantially greater than the efficiency obtained with conventional signaling devices, the efficiency of the device according to the invention being of the order of 70%.

The orientation of the optical axes of the lighting elements with respect to the direction to be lit makes it possible not only to decrease the energy consumption of the signaling device, but also to reduce the number of lighting elements necessary to obtain a luminous beam exhibiting a required intensity, that may be imposed by regulations, according to a desired lighting profile.

It thus becomes possible to obtain a luminous signaling device equipped with a reduced number of lighting elements, thus favoring the compactness of the device.

Advantageously, the reflecting surface stems from a substantially conical generator, the optical axes of the lighting elements being oriented substantially perpendicularly with respect to the axis of the said generator.

Preferably, the reflecting surface exhibits a symmetry of revolution along an axis substantially perpendicular with respect to the axis of the generator of the reflecting surface.

In other words, the reflection surface exhibits a symmetry of revolution along an axis substantially parallel to the optical axes of the lighting elements. Such a reflection surface has the advantage of allowing the design of a particularly compact signaling device.

Advantageously, the reflection elements are adapted for ensuring an increase in the intensity of the radiation emitted in a first angular sector and are fashioned in such a way as to allow the emission of rays stemming from the lighting elements directly towards a second angular sector, the said first and second angular sectors forming an angular span according to which the radiation must be emitted.

In other words, the reflection elements include not only a function of orienting the radiation emitted by the lighting elements, but also a collimating function making it possible to satisfy requirements, if any, pertaining to regulations. Specifically, when the signaling device is on board an aircraft, it is subject to certain regulations, and in particular to the FAR (Federal Aviation Regulations) imposing particular requirements pertaining to the characteristics of the luminous radiation emitted, in terms of intensity and spans of emission. The reflection elements are thus adapted so as to comply with these requirements.

The reflecting surface may be generated by a portion of a parabola, the lighting elements being positioned substantially at the focus of the parabola.

Advantageously, the parameter of the parabola formed by the reflecting surface and the position of each of the lighting elements constitutes an element for shaping the radiation emitted by the said lighting elements.

In one embodiment, the generator of the reflecting surface is a semi-parabola. Such an embodiment makes it possible to further augment the compactness of the device making it possible in particular to decrease the drag of the device when it is mounted on an aircraft.

The lighting elements may include electroluminescent diodes. The use of electroluminescent diodes to produce the luminous radiation is advantageous, insofar as these diodes exhibit a relatively significant lifetime, substantially greater than that of incandescent lamps, thus requiring less frequent maintenance operations.

Advantageously, the reflecting surfaces of the reflection elements are surface-treated.

Preferably, the radiation-shaping elements are constituted by the reflection elements.

Advantageously, the device includes a disc-shaped circuit on which the lighting elements are mounted.

In one embodiment, the luminous signaling device, in particular intended to be mounted on board an aircraft, is provided with first and second groups of lighting elements mounted respectively on first and second circuits, with first and second reflection elements able to intercept light rays stemming respectively from the first and second groups of lighting elements for the shaping of the radiation emitted. The reflection elements include reflecting surfaces provided with at least one substantially conical portion and the optical axes of the lighting elements being oriented substantially perpendicularly with respect to a direction to be lit.

According to a general characteristic, the first reflection element is mounted axially between the first and second circuits.

With such a device, it then becomes possible to obtain luminous radiation with an asymmetric angular distribution in a half-space. This is made possible in particular through the arrangement of the reflection elements on one and the same side of a support base of the device.

In other words, the luminous radiation reflection elements are disposed in such a way as to be oriented in one and the same general direction, for example vertically upwards.

This therefore provides two rows, or stages, of reflection elements axially offset with respect to one another, on one and the same side of a plane. The reflection elements are stacked.

### BRIEF DESCRIPTION OF THE DRAWINGS

The present invention will be better understood on reading the detailed description of embodiments taken by way of wholly nonlimiting example and illustrated by the appended drawings, in which:

FIG. 1 is a side view in elevation of a luminous signaling device according to a first embodiment of the invention;

FIG. 2 is a partial view of the signaling device of FIG. 1;

FIG. 3 is a diagram illustrating the required angular distribution of the radiation for the signaling device of FIG. 1;

FIG. 4 is a graph illustrating the angular distribution of the radiation emitted by the signaling device of FIG. 1 with respect to a distribution required by regulations, and

FIG. 5 is a side view in elevation of a luminous signaling device according to a second embodiment of the invention.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

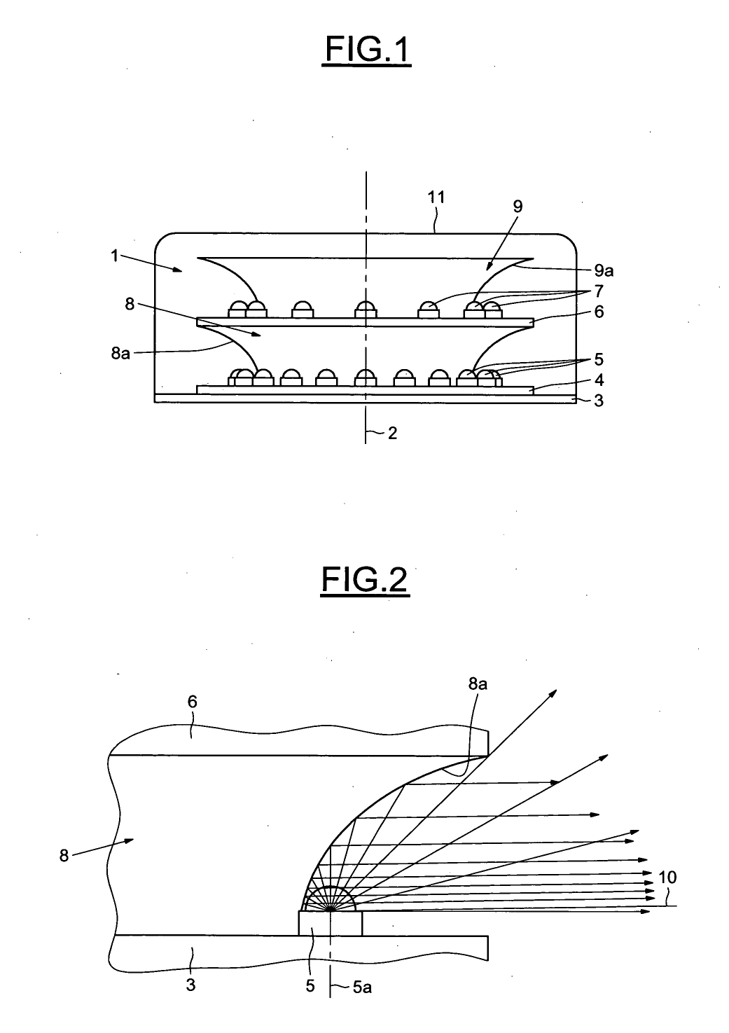

As may be seen in FIG. 1, the luminous signaling device, referenced 1 overall, extends substantially along an axis 2 assumed vertical.

The device 1 is intended to be mounted on an aircraft, for example a helicopter or an airplane, and to emit luminous signals in the form of periodic flashes so as to signal the presence of the aircraft on which it is mounted and thus constitute an anti-collision device.

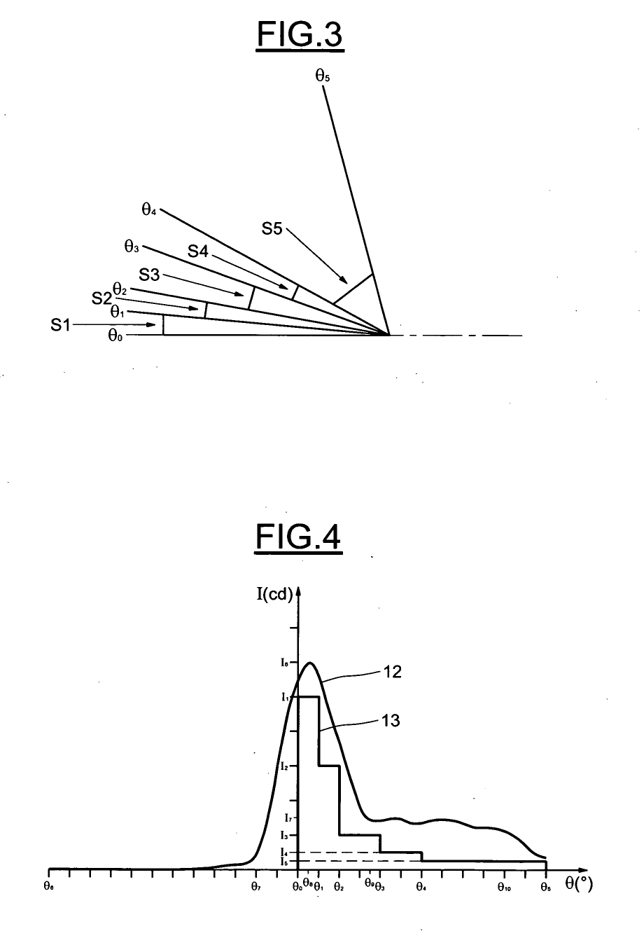

Referring to FIG. 3, the device 1 must emit, when operating, luminous radiation over 360° in a horizontal plane, and according to an angular distribution asymmetric in a vertical plane, the said distribution extending for example from 0° to +75° with respect to the horizontal plane.

The angular distribution in the vertical plane to be complied with decreases in tiers and includes successive angular sectors each constituting an intensity tier. The angular sectors form an angular span according to which the radiation is to be emitted.

The angular distribution includes a first angular sector S1 extending between θ₀ and θ₁, respectively equal to 0° and +5°, with respect to the horizontal plane, in which the required effective intensity of the radiation is a maximum and, for example at least equal to 600 cd. The said effective intensity is calculated according to the Blondel-Rey law.

Of course, it is also conceivable to envisage various levels of minimum intensity of radiation, for example 400 cd, 150 cd, or else 100 cd. This intensity is the minimum intensity to be complied with in respect of the device 1, inside this angular sector.

A second angular sector S2 extends between θ₁ and θ₂ with respect to the horizontal plane, θ₂ being equal to +10°, in which the intensity of the radiation corresponds to 60% of the maximum radiation intensity. A third angular sector S3 extends between θ₂ and θ₃, θ₃ being equal to +20°, in which the intensity of the radiation corresponds to 20% of the maximum radiation intensity. A fourth angular sector S4 extends between θ₃ and θ₄ with respect to the horizontal plane, θ₄ being equal to +30°, in which the intensity of the radiation is equal to 10% of the maximum radiation intensity. Finally, a fifth sector S5 extending between θ₄ and θ₅ with respect to the horizontal plane, θ₅ being equal to +75°, in which the intensity of the radiation is of the order of 5% of the maximum radiation intensity.

Referring again to FIG. 1, to obtain such an angular distribution, the signaling device 1 includes a base 3, here cylindrical, provided on a face with a first circuit 4.

The circuit 4 of cylindrical general shape, exhibiting a peripheral edge substantially offset inwards with respect to the peripheral edge of the base 3, includes a first group of lighting elements 5 circumferentially regularly distributed in proximity to the periphery of the first circuit 4, here 12 in number. The lighting elements 5 are arranged on an upper face of the circuit 4, the lower face of the circuit 4 being fixed on the base 3 which will itself be mounted on the aircraft.

The circuit 4, associated with a power supply source (not represented), is able to deliver to the first group of lighting elements 5 a supply signal, for example in notch form, exhibiting a frequency appropriate to be able to bring about the emission of flashes according to a predetermined period, for example of 45 flashes/minute. The first group of lighting elements 5 is mounted on an upper face of the circuit 4, the lower face of the circuit 4 being mounted on the base of large diameter 3 that will itself be mounted on the aircraft.

The device 1 also includes a second cylindrical circuit 6 exhibiting a radial dimension substantially less than the radial dimension of the first circuit 4. The circuit 6 may be obtained by assembling two half-circuits in the form of a U (not represented), or exhibit a general disc shape.

The circuit 6 is offset axially upwards with respect to the circuit 4, and fixed rigidly on the latter (not represented). The circuit 6 includes a second group of lighting elements 7 distributed regularly circumferentially in proximity to the periphery of the circuit 6, here 20 in number and linked to the power supply source associated with the circuit 4. The lighting elements 5, 7 of the first and second groups are substantially arranged at one and the same radial distance from the axis 2. The lighting elements of the first and second groups 5, 7 include electroluminescent diodes, for example of the Lumileds LUXEON® 1W type, emitting inside a solid angle of 2π steradians.

The device 1 includes elements for shaping the radiation emitted by the first and second groups of lighting elements 5, 7, including reflection elements 8 and 9, such as reflectors, provided respectively with a reflecting surface 8a, 9a including a substantially conical portion and here exhibiting an axial cross section of semi-parabolic general shape. Here, “surface including a substantially conical portion” is understood to mean a surface generated by a conic or else a surface generated by a succession of circles or of segments that are continuous by tangency and may be regarded as a conic.

The reflection element 8 is mounted axially between the upper face of the said circuit 4 and the lower face of the second circuit 6. The reflection element 8 is attached and fixed, at the level of the base 3, in proximity to the first group of lighting elements 5 while being offset radially inwards. The reflection element 9 is mounted, in a similar manner, on the base 3 in proximity to the second group of lighting elements 7 while being offset radially inwards. The reflecting surfaces 8a, 9a are here concave, it is however conceivable to envisage convex reflecting surfaces 8a, 9a. The reflection elements 8, 9 are advantageously optically treated and exhibit a capacity of reflection of the radiation intercepted of the order of 90%.

The reflection elements 8, 9 for reflecting the radiation emitted jointly by the first and second groups of lighting elements 5, 7 arranged in such a way as to emit a part of the radiation in the direction of the reflecting surfaces 8a, 9a and allow the obtaining of radiation of uniform intensity, distributed horizontally according to an angle of 360° and having a vertical distribution, complying with the vertical distribution visible in FIG. 3. The reflection elements 8, 9 ensure an increase in the intensity of the radiation emitted according to a first angular span, corresponding to the first angular sector S1, S2 (FIG. 3) which extends between 0 and +10°, the lighting elements 5, 7 emitting directly a luminous beam in a second angular span corresponding to the angular sector S3, S4 and S5 (FIG. 3) which extends between +10° and +75°.

As illustrated in FIG. 2, the reflecting surface 8a of the light reflection element 8 is disposed in such a way as to intercept the light rays stemming from the first group of lighting elements 5, which are emitted according to an angle substantially greater than 75° with respect to a horizontal plane, and returned according to the admissible angular span with an elevation in the intensity of the radiation emitted by virtue of the shape of the reflecting surface 8a.

The reflecting surface 8a is generated by the rotation of a semi-parabolic generator about the axis 2, the generator having equation y=(2px)^{1/2}. The axis 2 of revolution of the semi-parabola is here substantially perpendicular with respect to an axis 10 of the generator of the reflecting surface 8a, which axis is directed substantially along the direction to be lit. The angular offset of the axis 10 of the generator with respect to a substantially horizontal axis may be between 0 and 10°. An outside edge, situated in proximity to the circuit 6, of the reflecting surface 8a is offset radially outwards with respect to the lighting elements 5.

The lighting elements 5 are preferably positioned at the level of the focus of the semi-parabola. The lighting elements 5 are arranged on the circuit 4, each of the optical axes 5a, or axes of orientation, of the lighting elements 5 being substantially oriented perpendicularly with respect to the axis 10 of the generator of the reflecting surface 8a. Stated otherwise, the lighting elements 5 are positioned in such a way as to emit mainly a luminous radiation towards the reflecting surface 8a of the reflection element 8, that is to say upwards.

It will be noted that the parameter p of the equation of the generator that produces the reflecting surface 8a as well as the position of the lighting elements 5 of the first group with respect to the focus of this semi-parabola, are chosen in such a way as to obtain, after reflection, parallel rays. The reflecting surface 8a of the light reflection element 8 makes it possible to return the radiation emitted with an increase in the luminous intensity of the radiation.

In a similar manner, the reflecting surface 9a of the reflection element 9 exhibits a transverse cross section of semi-parabolic shape which satisfies the relation y=(2px)^{1/2} fashioned and oriented in such a way as to intercept the light rays stemming from the lighting elements 7 emitted according to an angle substantially greater than 60°, with a view to being returned according to the admissible angular span. The parameter p of the equation of the parabola forming the reflecting surface 9a is also 2. The light elements 7 are arranged substantially at the focus of the semi-parabola so as to obtain parallel reflected light rays. The lighting elements 7 are arranged in such a way that each of the optical axes of the said elements 7 is substantially perpendicular to an axis of the generator of the reflection surface 9a.

The device 1 also includes a hood 11 fixed on the periphery of the base 3 and shrouding the various elements of the device. The hood 11 is transparent or translucent to light and may be made for example of a molded synthetic material. The hood 11 may be of cylindrical general shape, or streamlined for aerodynamic considerations.

The device 1 also includes a heat exchange element such as a radiator (not represented) that can be mounted at the level of the base 3 so as to allow the removal, from the device 1, of the heat generated by the emission of the radiation emitted by the lighting elements 5, 7 and the reflection of the said radiation. The reflection elements 8, 9 are, preferably, mounted directly on the radiator so as to allow good removal of the heat. It is also conceivable to envisage making the radiator in one piece with the reflection elements 8, 9 in such a way as to augment the removal of heat. The radiator can exhibit an oval shape extending substantially along the axis 10 in such a way as to reduce any drag when the device 1 is mounted on an aircraft.

During operation, the luminous radiation stemming from the lighting elements 5, 7 are recovered respectively by the reflecting surfaces 8a, 9a of the reflection elements 8, 9 so as to be reflected in the form of a set of rays emitted substantially in parallel according to the admissible angular span, that is to say lying between zero and 75°.

The use of reflecting surfaces 8a, 9a exhibiting a substantially conical transverse cross section, and preferably of semi-parabolic general shape, as well as the relative arrangement of these surfaces 8a, 9a exhibit the advantage of being able to render asymmetric the luminous radiation emitted by the lighting elements 5, 7 according to the admissible angular span, but also to obtain an increase in the intensity of the radiation emitted according to a first angular span which extends here between 0° and +10°.

Of course, it is also conceivable to envisage reflecting surfaces 8a, 9a having an ellipsoidal or hyperbolic axial cross section. It is also conceivable to envisage reflecting surfaces that can be regarded, for example, as a parabola, and consisting of a plurality of plane facets.

FIG. 4 represents the angular distribution of the luminous intensity of the radiation emitted by the luminous signaling device and the angular distribution required by regulations to be complied with, respectively by the curves 12 and 13.

The angular distribution of the luminous radiation emitted, essentially asymmetrical, must extend between θ₀ and θ₅. The angular distribution to be complied with 13 decreases in tiers and includes various successive angular sectors. The distribution includes a first tier in which the intensity of the radiation corresponding to I₁ is a maximum, a second tier in which the intensity of the radiation I₂ corresponds to 60% of the intensity I₁, a third tier in which the intensity of the radiation I₃ corresponds to 20% of the intensity I₁, a fourth tier in which the intensity of the radiation I₄ corresponds to 10% of the intensity I₁, and a fifth tier in which the intensity of the radiation I₅ corresponds to 5% of the intensity I₁.

For a first portion of the curve 12, which extends between θ₆ and θ₇ equal respectively to −75° and −10°, the luminous intensity is substantially zero. A second ascending portion of the curve 12, extending between θ₇ and θ₈ and equal to around 5°, exhibits a substantially constant slope and includes a maximum value of intensity I₈ corresponding substantially to 120% of the intensity I₁, the said second portion is prolonged by a third descending portion, extending between θ₈ and θ₉ and equal to around 17.5°, which exhibits a slope substantially opposite to that of the second portion. A fourth portion of substantially zero slope extends between θ₉ and θ₁₀ and equals 50°, then a fifth descending portion extending between θ₁₀ and θ₅, the luminous intensity emitted by the device 1 being substantially greater than the luminous intensity required I₅ at the level of θ₅. Whatever the angle, the luminous intensity emitted by the luminous signaling device (curve 12) is greater than the luminous intensity defined by the regulations (curve 13).

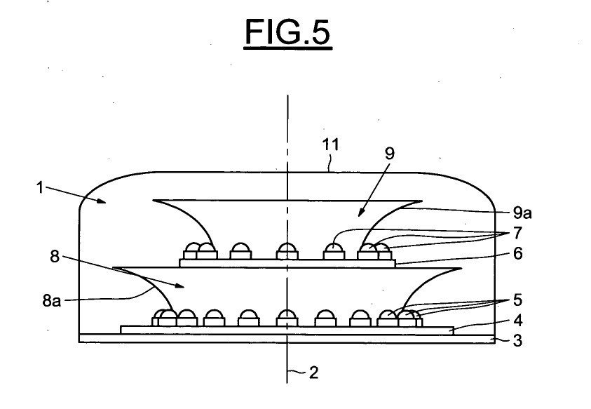

The variant embodiment illustrated in FIG. 5, in which the identical elements bear the same references, differs in that the reflection element 9 exhibits a radial dimension reduced with respect to the radial dimension of the reflection element 8. Stated otherwise, the peripheral edge of the reflection element 8 is offset radially in an external manner, when considering the axis 2, with respect to the peripheral edge of the reflection element 9. It thus becomes possible to design a circuit 6 exhibiting a peripheral edge offset radially inwards with respect to the lower end of the reflection element 8 while mounting the lighting elements 7 at the focus of the semi-parabola defining the reflecting surface 9a. With such an arrangement, the circuit 6 may thus advantageously be formed from a single prefabricated ring on which the lighting elements 7 are mounted while yet allowing easy mounting of the reflection element 8.

In a variant embodiment, it may also be conceivable to envisage a device 1 including a single reflection element or a device 1 including a number of reflection elements greater than two according to the level of intensity of the beam required or desired.

Whatever the embodiment, the luminous signaling device makes it possible to obtain dissymetrization of the radiation stemming from the lighting elements according to an angular span and a local elevation in the intensity of the radiation emitted without it being necessary to envisage specific elements able to elevate the said intensity, the reflection of the radiation as well as the local elevation in the intensity being effected by means of a single radiation-shaping element.

Furthermore, the use of reflecting surfaces having a transverse cross section in the general shape of a semi-parabola as well as the orientation of the optical axes of the lighting elements in a manner substantially perpendicular with respect to the axis of the generator of the reflecting surface, makes it possible to obtain an especially compact device.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. Luminous signaling device, in particular intended to be mounted on board an aircraft, comprising a plurality of lighting elements mounted on a support and elements for shaping the radiation emitted jointly by the lighting elements, the said shaping elements being provided with reflection elements whose reflecting surfaces comprise at least one substantially conical portion, wherein the optical axes of the lighting elements are oriented substantially perpendicularly with respect to a direction to be lit.

2. Device according to claim 1, wherein the reflecting surface stems from a substantially conical generator, the lighting elements being oriented substantially perpendicularly with respect to the axis of the said generator.

3. Device according to claim 2, wherein the reflecting surface exhibits a symmetry of revolution along an axis substantially perpendicular with respect to the axis of the generator of the reflecting surface.

4. Device according to claim 1, wherein the reflection elements are adapted for ensuring an increase in the intensity of the radiation emitted in a first angular sector and are fashioned in such a way as to allow the emission of rays stemming from the lighting elements directly towards a second angular sectors , the said first and second angular sectors forming an angular span according to which the radiation must be emitted.

5. Device according to claim 1, wherein the reflecting surface is generated by a portion of a parabola, the lighting elements being positioned substantially at the focus of the parabola.

6. Device according to claim 5, wherein the generator of the reflecting surface is a semi-parabola.

7. Device according to claim 1, wherein the lighting elements comprise electroluminescent diodes.

8. Device according to claim 1, wherein the reflecting surface of the reflection elements are surface-treated.

9. Device according to claim 1, wherein the radiation-shaping elements are constituted by the reflection elements.

10. Device according to claim 1, further comprising a disc-shaped circuit which the lighting elements are mounted.
